(19) United States
(12) Patent Application Publication
(10) Pub. No.: US 2025/0203434 A1
(43) Pub. Date: Jun. 19, 2025

(54) BEAM REPORTING IN A WIRELESS COMMUNICATION SYSTEM

(71) Applicant: Samsung Electronics Co., Ltd., Suwon-si (KR)

(72) Inventor: Anil Agiwal, Allen, TX (US)

(21) Appl. No.: 18/948,187

(22) Filed: Nov. 14, 2024

Related U.S. Application Data
(60) Provisional application No. 63/609,630, filed on Dec. 13, 2023.
(60) Provisional application No. 63/658,132, filed on Jun. 10, 2024.

(51) Int. Cl. H04W 24/10; H04B 17/318; H04W 72/21

(52) U.S. Cl. CPC H04W 24/10; H04B 17/328; H04W 72/21

(57) ABSTRACT

A user equipment (UE) includes a processor, and a transceiver operatively coupled to the processor. The transceiver is configured to transmit, to a base station (BS), a message indicating a UE initiated beam reporting capability, and receive, from the BS, a UE initiated beam reporting configuration for at least one cell, the UE initiated beam reporting configuration including a list of at least one candidate reference signals (RSs). The transceiver is also configured to receive, from the BS, a message including a configuration for a counter threshold and a beam reporting trigger timer, and transmit, to the BS, a UE initiated beam report.

### CROSS-REFERENCE TO RELATED APPLICATION(S) AND CLAIM OF PRIORITY

This application claims priority under 35 U.S.C. § 119 (e) to U.S. Provisional Patent Application No. 63/609,630 filed on Dec. 13, 2023, and U.S. Provisional Patent Application No. 63/658,132 filed on Jun. 10, 2024. The above-identified provisional patent applications are hereby incorporated by reference in their entirety.

### TECHNICAL FIELD

This disclosure relates generally to wireless networks. More specifically, this disclosure relates to beam reporting in a wireless communication system.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for beam reporting in a wireless communication system.

In one embodiment a user equipment (UE) is provided. The UE includes a processor, and a transceiver operatively coupled to the processor. The transceiver is configured to transmit, to a base station (BS), a message indicating a UE initiated beam reporting capability, and receive, from the BS, a UE initiated beam reporting configuration for at least one cell, the UE initiated beam reporting configuration including a list of at least one candidate reference signals (RSs). The transceiver is also configured to receive, from the BS, a message including a configuration for a counter threshold and a beam reporting trigger timer, and transmit, to the BS, a UE initiated beam report.

In another embodiment, a BS is provided. The BS includes a processor, and a transceiver operatively coupled to the processor. The transceiver is configured to transmit, to the UE, a UE initiated beam reporting configuration for at least one cell, the UE initiated beam reporting configuration including a list of at least one candidate RSs. The transceiver is also configured to transmit, to the UE, a message including a configuration for a counter threshold and a beam reporting trigger timer, and receive, from the UE, a UE initiated beam report.

In yet another embodiment, a method of operating UE is provided. The method includes transmitting, to a BS, a message indicating a UE initiated beam reporting capability, and receiving, from the BS, a UE initiated beam reporting configuration for at least one cell, the UE initiated beam reporting configuration including a list of at least one candidate RSs. The method also includes receiving, from the BS, a message including a configuration for a counter threshold and a beam reporting trigger timer, and transmitting, to the BS, a UE initiated beam report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example method for UE triggered beam reporting according to embodiments of the present disclosure;

FIG. 5 illustrates another example method for UE triggered beam reporting according to embodiments of the present disclosure;

FIG. 6 illustrates another example method for UE triggered beam reporting according to embodiments of the present disclosure;

FIG. 7 illustrates another example method for UE triggered beam reporting according to embodiments of the present disclosure;

FIG. 8 illustrates another example method for UE triggered beam reporting according to embodiments of the present disclosure;

FIG. 9 illustrates another example method for UE triggered beam reporting according to embodiments of the present disclosure; and

FIG. 10 illustrates another example method for UE triggered beam reporting according to embodiments of the present disclosure.

### DETAILED DESCRIPTION

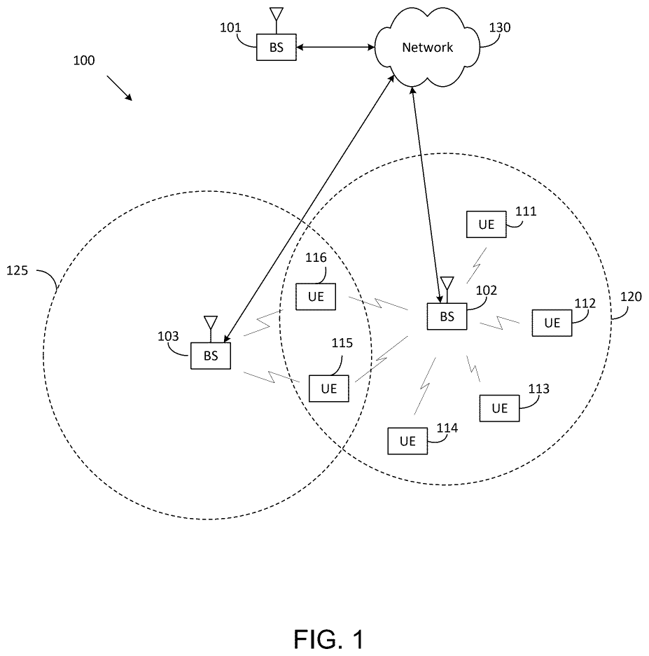

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for beam reporting in a wireless communication system. In certain embodiments, one or more of the gNBs 101-103 includes circuitry, programing, or a combination thereof, to support beam reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

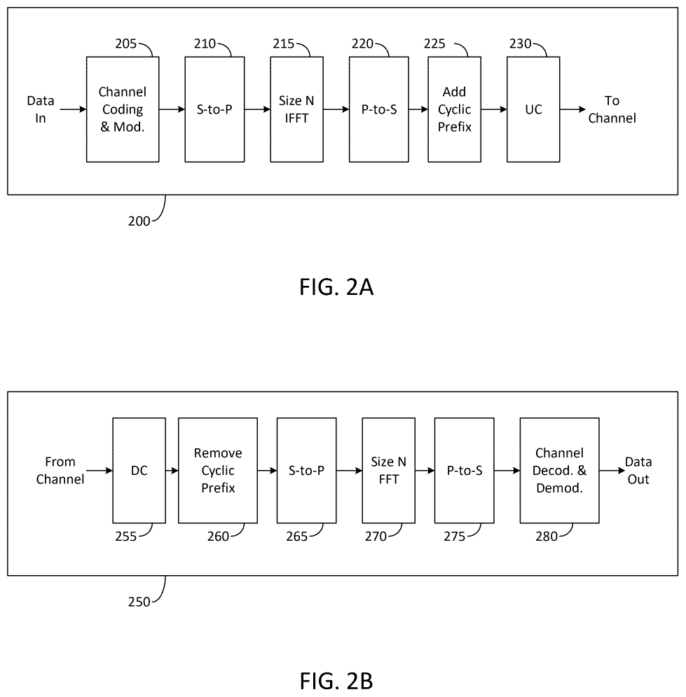

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support beam reporting in a wireless communication system as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols.

The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

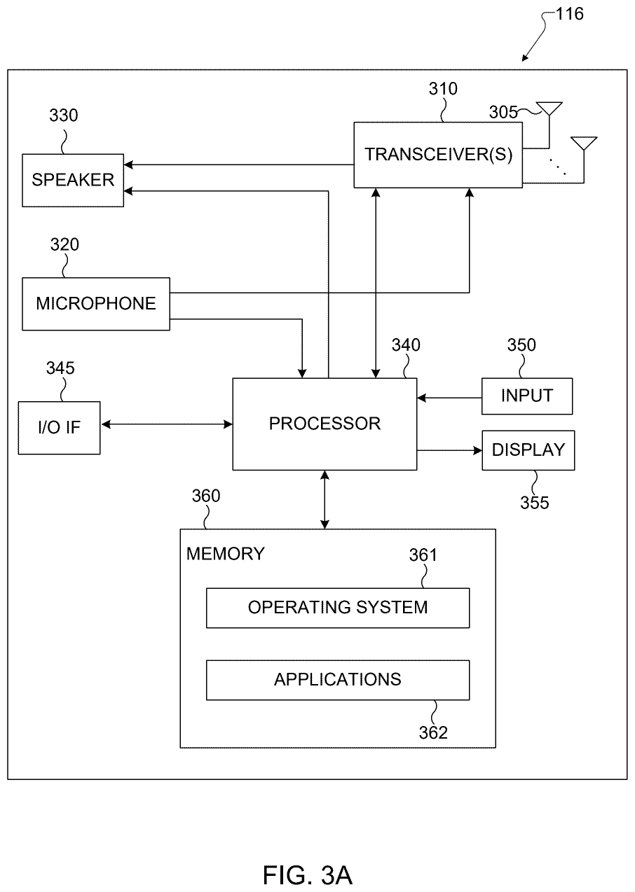

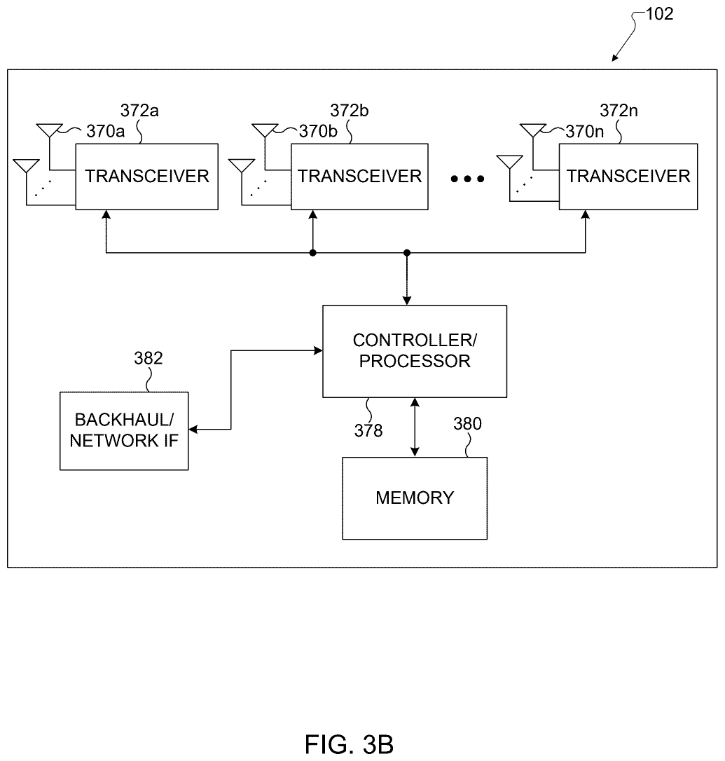

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for beam reporting in a wireless communication system as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support beam reporting in a wireless communication system as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. beamforming techniques are used to mitigate propagation path losses and to increase the propagation distance for communication at higher frequency band. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. The next generation wireless communication system (e.g., 5G, beyond 5G, 6G) system operating at high frequency uses a plurality of narrow TX beams to transmit signals in the cell as each narrow TX beam provides coverage to a part of cell. The narrower the TX beam, the higher the antenna gain and hence the larger the propagation distance of the signal transmitted using beamforming. A receiver can also generate a plurality of receive (RX) beam patterns of different directions. Each of these receive patterns can be also referred as a receive (RX) beam.

The next generation wireless communication system (e.g., 5G, beyond 5G, 6G) wireless communication system supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED configured state with CA/DC the term ‘serving cells’ is used to denote the set of cells comprising the Special Cell(s) (SpCell [s]) and all secondary cells. In NR the term Master Cell Group (MCG) refers to a group of serving cells associated with the Master Node, comprising the primary cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR PCell refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of a Special Cell. PSCell refers to a serving cell in a SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

In the next generation wireless communication system (e.g., 5G, beyond 5G, 6G), the Physical Downlink Control Channel (PDCCH) is used to schedule DL transmissions on the Physical Downlink Shared Channel (PDSCH) and UL transmissions on the Physical Uplink Shared Channel (PUSCH), where Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for a physical uplink control channel (PUCCH) and physical uplink shared channel (PUSCH); transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating different numbers of CCEs. Interleaved and non-interleaved CCE-to-REG mapping are supported in a CORESET. Polar coding is used for the PDCCH. Each resource element group carrying the PDCCH carries its own Demodulation reference signal (DMRS). QPSK modulation is used for the PDCCH.

In the next generation wireless communication system (e.g., 5G, beyond 5G, 6G), a list of search space configurations is signaled by the gNB for each configured bandwidth part (BWP) of the serving cell, wherein each search configuration is uniquely identified by a search space identifier. A search space identifier is unique amongst the BWPs of a serving cell. An identifier of the search space configuration to be used for a specific purpose such as paging reception, SI reception, random access response reception is explicitly signaled by the gNB for each configured BWP. In NR, a search space configuration comprises parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters for the PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations are signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. Each Radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each coreset configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. A TCI state indicates the DL TX beam (the DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP (i.e., the UE does not have to monitor PDCCH on the entire DL frequency of the serving cell). In the RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a point in time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either an RRC or the PDCCH. For unpaired spectrum, a DL BWP is paired with a UL BWP, and BWP switching is common for both UL and DL. Upon expiry of a BWP inactivity timer, the UE switches from the active DL BWP to the default DL BWP, or initial DL BWP (if a default DL BWP is not configured).

In the next generation wireless communication system (e.g., 5G, beyond 5G, 6G), random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in the RRC CONNECTED state. Several types of random access procedure are supported such as 4 step contention based random access (CBRA), 4 step contention free random access (CFRA), 2 step CBRA and 2 step CFRA.

In contention based random access (CBRA), also referred to as 4 step CBRA, the UE first transmits a random access preamble (also referred to as a Msg1) and then waits for a random access response (RAR) in the RAR window. The RAR is also referred to as a Msg2. The gNB transmits the RAR on the PDSCH. A PDCCH scheduling the PDSCH carrying the RAR is addressed to a RA-radio network temporary identifier (RA-RNTI). The RA-RNTI identifies the time-frequency resource (also referred to as a physical RA channel (PRACH) occasion or PRACH transmission (TX) occasion or RA channel (RACH) occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤ t_id<80); f_id is the index of the PRACH occasion within the slot in the frequency domain (0≤ f_id<8), and ul_carrier_id is the UL carrier used for the Msg1 transmission (0 for normal UL (NUL) carrier and 1 for supplementary UL (SUL) carrier. Several RARs for various Random-access preambles detected by the gNB can be multiplexed in the same RAR media access control (MAC) protocol data unit (PDU) by the gNB. A RAR in the MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., selecting a random access resource [preamble/RACH occasion]) and transmits the RA preamble. A backoff may be applied before going back to the first step.

If the RAR corresponding to its RA preamble transmission is received the UE transmits a message 3 (Msg3) in the UL grant received in the RAR. The Msg3 includes a message such as an RRC connection request, RRC connection re-establishment request, RRC handover confirm, scheduling request, SI request etc. The Msg3 may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (the first X bits of a common control channel [CCCH] service data unit [SDU] transmitted in the Msg3), contention resolution is considered successful, the contention resolution timer is stopped, and the RA procedure is completed. If the contention resolution timer expires and UE has not yet transmitted the RA preamble for a configurable number of times, the UE goes back to the first step (i.e., selecting a random access resource [preamble/RACH occasion]) and transmits the RA preamble. A backoff may be applied before going back to first step.

Contention free random access (CFRA), is also referred to as legacy CFRA or 4 step CFRA, is used for scenarios such as handover where low latency is required, timing advance establishment for a secondary cell (Scell), etc. An Evolved node B (eNB) assigns to the UE a dedicated random access preamble. The UE transmits the dedicated RA preamble. The eNB transmits a RAR on a PDSCH addressed to the RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such has handover and beam failure recovery if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there is no SSB/CSI RS that has a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. During the RA procedure, one random access attempt can be CFRA while another random access attempt can be CBRA.

In 2 step contention based random access (2 step CBRA), in the first step, the UE transmits a random access preamble on a PRACH and a payload (i.e., MAC PDU) on a PUSCH. The random access preamble and payload transmission are also referred to as MsgA. In the second step, after the MsgA transmission, the UE monitors for a response from the network (i.e., gNB) within a configured window. The response is also referred to as a MsgB. The gNB transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; OS s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL (NUL) carrier and 1 for supplementary UL (SUL) carrier.

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting the Msg3), the UE retransmits the MsgA. If the configured window in which the UE monitors for the network response after transmitting the MsgA expires and the UE has not received a MsgB including contention resolution information or fallback information as explained above, the UE retransmits the MsgA. If the random access procedure is not successfully completed even after transmitting the MsgA a configurable number of times, the UE falls back to 4 step RACH procedure i.e., the UE only transmits the PRACH preamble.

A MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include UE ID (e.g., random ID, S-TMSI, C-RNTI, resume ID, etc.) along with the preamble in the first step. The UE ID may be included in the MAC PDU of the MsgA. The UE ID such as C-RNTI may be carried in the MAC CE wherein the MAC CE is included in MAC PDU. Other UE IDs (such as random ID, S-TMSI, C-RNTI, resume ID, etc.) may be carried in the CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is a random ID. When the UE performs RA in an IDLE state after it is attached to the network, the UE ID is an S-TMSI. If the UE has an assigned C-RNTI (e.g., in a connected state), the UE ID is the C-RNTI. In case the UE is in an INACTIVE state, the UE ID is a resume ID. In addition to the UE ID, some addition control information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE a dedicated Random access preamble(s) and PUSCH resource(s) for a MsgA transmission. RO(s) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after MsgA transmission, the UE monitors for a response from the network (i.e., gNB) within a configured window. The response is also referred to as a MsgB.

The gNB transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14× 80×8×2, where s_id is the index of the first orthogonal frequency division multiplexing (OFDM) symbol of the PRACH occasion where UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL (NUL) carrier and 1 for supplementary UL (SUL) carrier.

If the UE receives a PDCCH addressed to the C-RNTI, the random access procedure is considered successfully completed. If the UE receives fallback information corresponding to its transmitted preamble, the random access procedure is considered successfully completed.

In the next generation wireless communication system (e.g., 5G, beyond 5G, 6G), beam management is supported. In existing beam management and/or mobility procedures, the network may configure/activate frequent periodic or semi-persistent beam reporting (e.g., the N best beams and corresponding layer 1 received signal reference powers [L1-RSRPs]) or triggers frequent aperiodic beam reporting to timely acquire the best/preferred beam for data/control transmissions and/or identify candidate cell for mobility. However, this results in large UL reporting overhead and control signaling overhead. At the same time, if less frequent beam reporting is configured, the network may be unable to acquire the ‘best/preferred’ beam(s) as the beam reporting by the UE may be outdated, thus leading to performance degradation. Given that the UE has better and more-timely knowledge of beam quality changes, a UE-initiated beam reporting procedure can lead to more timely beam reports with reduced reporting overhead. Under such a procedure, if the UE determines that e.g., current beam(s) quality becomes poor, the UE can trigger beam reporting without the network configuring or triggering frequent reporting. Various embodiments of the present disclosure provide for quick and efficient UE triggered beam reporting to the network.

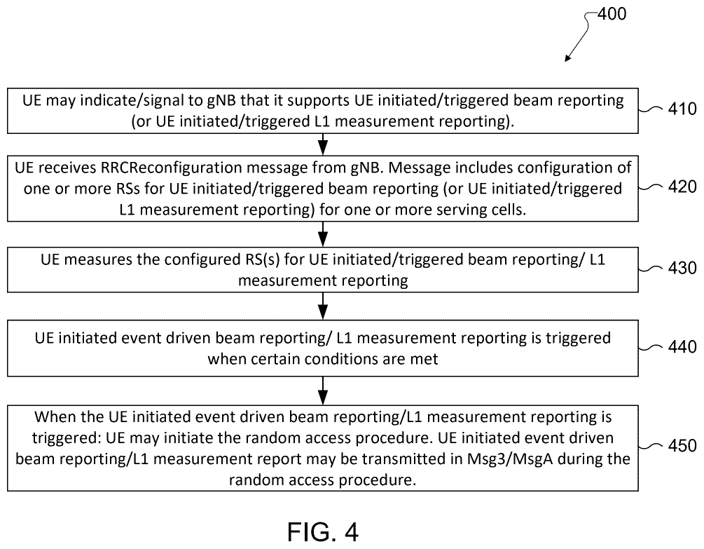

FIG. 4 illustrates an example method for UE triggered beam reporting 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

In the example of FIG. 4, method 400 is performed by a UE such as UE 116 of FIG. 1. In some embodiments, the UE may be in an RRC_CONNECTED state. In some embodiments, the UE may be in an RRC_IDLE/RRC_INACTIVE state.

Method 400 begins at step 410, which is an optional step. At step 410, the UE may indicate/signal to a gNB (e.g., BS 102 of FIG. 1) that the UE supports UE initiated/triggered beam reporting (or UE initiated/triggered L1 measurement reporting) capability. This capability may be signaled per UE (which means that the UE supports or does not support UE initiated/triggered beam reporting [or UE initiated/triggered L1 measurement reporting] irrespective of any frequency band). Alternately, this capability may be signaled per frequency band (or per FR1/FR2 etc.), wherein UE may support UE initiated/triggered beam reporting (or UE initiated/triggered L1 measurement reporting) for some frequency bands, all frequency bands, or no frequency bands. Alternately, this capability may be signaled per frequency band combination. Alternately, this capability may be signaled per band per band combination. Alternately, this capability may be signaled per component carrier per band per band combination (feature set per component carrier). In some embodiments, this capability may be signaled by the UE to the gNB via an RRC message (e.g., UE a capability information message, RRC Resume Complete message, RRC connection setup complete message, a new message, etc.). In some embodiments, this capability may be signaled by the UE to the gNB upon receiving request from the gNB. In some embodiments, this capability may be signaled by the UE to the gNB upon entering an RRC_CONNECTED state. In some embodiments, this capability may be signaled by the UE to the gNB when the UE is configured with a serving cell (e.g., a PCell, PSCell, SCell, camped cell, neighbor cell, candidate cell for cell switch or handover etc.) with multiple beams (or RSs QCLed with beams/SSBs).

At step 420, the UE receives an RRCReconfiguration message from the gNB. In some embodiments, the message includes configuration of one or more RSs for UE initiated/triggered beam reporting (or UE initiated/triggered L1 measurement reporting) for one or more serving cells (e.g., a PCell, PSCell, SCell, camped cell, neighbor cell, candidate cell for cell switch or handover etc.).

At step 430, the UE performs the measurement (i.e., measures L1-RSRPs/RSRQs/SINRs etc. as configured, of the configured RSs for UE initiated/triggered beam reporting/L1 measurement reporting). In some embodiments, for SCells, the UE may not measure the SCell unless the SCell is activated.

At step 440, a UE initiated event driven beam reporting/L1 measurement reporting may be triggered for a serving cell (e.g., a PCell, PSCell, SCell, camped cell, neighbor cell, candidate cell for cell switch or handover etc.) when at least one of the following conditions is met:
a) A current active TCI state for PDCCH monitoring is below a threshold.
b) All RSs in a set of TCI states/RSs (configured by RRC for UE initiated/triggered beam reporting/L1 measurement reporting) are below a threshold. The threshold can be configured by the network (e.g., using RRC signaling or system information).
c) At least ‘N’ TCI states/RSs from a set of TCI states/RSs (configured by RRC for UE initiated/triggered beam reporting/L1 measurement reporting), are below a threshold. N can be fixed or configurable by RRC. The threshold can be configured by the network (e.g., using RRC signaling or system information).
d) At least one TCI state/RS from a set of TCI states/RSs (configured by RRC for UE initiated/triggered beam reporting/L1 measurement reporting), is below a threshold.
e) A current active TCI state for PDCCH monitoring is below a first threshold and at least one configured TCI state for PDCCH monitoring is above a second threshold. The first threshold and second threshold can be the same or different and may be configured by RRC.
f) All RSs in a set of TCI states/RSs (configured by RRC for UE initiated/triggered beam reporting/L1 measurement reporting) are below a first threshold and at least one TCI state/RS from a set of candidate TCI states/RSs (configured by RRC) is above a second threshold. The first threshold and second threshold can be the same or different and may be configured by RRC.
g) At least one TCI state/RS from a set of TCI states/RSs (configured by RRC for UE initiated/triggered beam reporting/L1 measurement reporting), is below a first threshold and at least one TCI state/RS from a set of (candidate) TCI states/RSs (configured by RRC) is above a second threshold. The first threshold and second threshold can be the same or different and may be configured by RRC.
h) At least ‘N’ TCI state/RS from a set of TCI states/RSs (configured by RRC), are below a first threshold (N can be fixed or configurable by RRC), and at least one TCI state/RS from a set of candidate TCI states/RSs (configured by RRC) is above a second threshold. The first threshold and second threshold can be the same or different and may be configured by RRC.

In some embodiments, the UE may receive a configuration “BeamReportingTriggerTimer” for a beam reporting trigger timer and/or a configuration “beamReportingTriggerInstanceMaxCount” (which is a threshold for a counter “BEAM_REPORTING_TRIGGER_COUNT”) from the gNB using an RRC signaling message. These configurations can be per serving cell, per cell group, or per BWP.

In some embodiments, for a serving cell, if the L1-RSRP of the new/candidate beam/RS (i.e., candidate RS in list of candidate RSs) of the serving cell becomes a threshold value better than the current beam (e.g., activated TCI state or RS QCLed with activated TCI state) of serving cell, the UE starts or restarts the BeamReportingTriggerTimer for the new/candidate beam (i.e., candidate RS in list of candidate RSs), and increments BEAM_REPORTING_TRIGGER_COUNT of the new/candidate beam/RS (i.e., a candidate RS in the list of candidate RSs) by 1. if BEAM_REPORTING_TRIGGER_COUNT of the new/candidate beam/RS is greater than or equal to beamReportingTriggerInstanceMaxCount, the UE triggers a UE initiated beam report. If the BeamReportingTriggerTimer for a new/candidate beam/RS expires, the UE sets BEAM_REPORTING_TRIGGER_COUNT of the new/candidate beam/RS to 0. If BeamReportingTriggerTimer and beamReportingTriggerInstanceMaxCount is reconfigured by upper layers (e.g., an RRC signaling message reconfiguring BeamReportingTriggerTimer and beamReportingTriggerInstanceMaxCount is received), the UE sets all BEAM_REPORTING_TRIGGER_COUNT instances to 0 (i.e., the UE sets BEAM_REPORTING_TRIGGER_COUNT to 0 for all new/candidate beam/RSs of serving cell(s) to which the reconfigured BeamReportingTriggerTimer and beamReportingTriggerInstanceMaxCount are applicable). If a UE initiated beam report for a serving cell is transmitted, the UE sets all BEAM_REPORTING_TRIGGER_COUNT instances (i.e., BEAM_REPORTING_TRIGGER_COUNT for all new/candidate beam/RSs of the serving cell) to 0.

In some embodiments, for a serving cell, if any of the events a) to h) described above is met, the UE starts or restarts the BeamReportingTriggerTimer for the serving cell, and increments) BEAM_REPORTING_TRIGGER_COUNT of the serving cell by 1. If BEAM_REPORTING_TRIGGER_COUNT of the serving cell is greater than or equal to beamReportingTriggerInstanceMaxCount, the UE triggers a UE initiated beam report. If the BeamReportingTriggerTimer for the serving cell expires, the UE sets BEAM_REPORTING_TRIGGER_COUNT of the serving cell to 0. If BeamReportingTriggerTimer and beamReportingTriggerInstanceMaxCount are reconfigured by upper layers (e.g., an RRC signaling message reconfiguring BeamReportingTriggerTimer and beamReportingTriggerInstanceMaxCount is received), the UE sets all BEAM_REPORTING_TRIGGER_COUNT instances to 0 (i.e., the UE sets BEAM_REPORTING_TRIGGER_COUNT to 0 for all new/candidate beam/RSs of serving cell(s) to which the reconfigured BeamReportingTriggerTimer and beamReportingTriggerInstanceMaxCount are applicable). If a UE initiated beam report for a serving cell is transmitted, the UE sets BEAM_REPORTING_TRIGGER_COUNT of the serving cell to 0.

In some embodiments, a UE initiated event driven beam reporting/L1 measurement reporting may be triggered if the measurement (e.g., L1-RSRP/L1-RSRQ) of a new/candidate beam/RS (i.e., a candidate RS in the list of candidate RSs) of a neighbor/candidate cell exceeds by a threshold value better a measurement of the current serving beam (e.g., activated TCI state or RS QCLed with activated TCI state) of the serving cell (i.e., PCell in MCG or PSCell in SCG) or if the measurement (e.g. L1-RSRP/L1-RSRQ) of a new/candidate beam/RS (i.e., candidate RS in list of candidate RSs) of a neighbor/candidate cell remains above a threshold value than a measurement of the current serving beam (e.g., activated TCI state or RS QCLed with activated TCI state) of the serving cell (i.e. PCell in MCG or PSCell in SCG) for a defined duration (the defined duration can be configured by the network using RRC signaling).

In some embodiments, a UE initiated event driven beam reporting/L1 measurement reporting may be triggered if the measurement (e.g. L1-RSRP/L1-RSRQ) of a new/candidate beam/RS (i.e., candidate RS in list of candidate RSs) of neighbor/candidate cell exceeds a threshold value or if the measurement (e.g., L1-RSRP/L1-RSRQ) of a new/candidate beam/RS (i.e., a candidate RS in the list of candidate RSs) of a neighbor/candidate cell exceeds a threshold value for a defined duration (the defined duration can be configured by the network using RRC signaling).

In some embodiments, a UE initiated event driven beam reporting/L1 measurement reporting may be triggered if the measurement (e.g., L1-RSRP/L1-RSRQ) of a new/candidate beam/RS (i.e., a candidate RS in the list of candidate RSs) of a neighbor/candidate cell exceeds a threshold value or if the measurement (e.g. L1-RSRP/L1-RSRQ) of a new/candidate beam/RS (i.e., candidate RS in list of candidate RSs) of a neighbor/candidate cell exceeds a threshold value for a defined duration (the defined duration can be configured by the network using RRC signaling).

In some embodiments, a UE initiated event driven beam reporting/L1 measurement reporting may be triggered, if the measurement (e.g., L1-RSRP/L1-RSRQ) of the current serving beam (e.g., activated TCI state or RS QCLed with activated TCI state) of the serving cell (i.e., PCell in MCG or PSCell in SCG) is below a threshold value or if the measurement e.g. L1-RSRP/L1-RSRQ of the current serving beam (e.g., activated TCI state or RS QCLed with activated TCI state) of the serving cell (i.e., PCell in MCG or PSCell in SCG) remains below a threshold value for a defined duration (defined duration can be configured by network using RRC signaling).

At step 450, when a UE initiated event driven beam reporting/L1 measurement reporting is triggered, the UE may initiate a random access procedure. The random access procedure can be for the SpCell. The UE initiated event driven beam reporting/L1 measurement report may be transmitted in a Msg3/MsgA during the random access procedure. In some embodiments, the UE may select a 4 step and/or 2 step random access procedure. In some embodiments, the random access procedure may be initiated if the RSRP of the RS in the activated UL TCI state (or TCI state for the PUSCH/PUCCH) of the SpCell is below a threshold or the RSRP of the RS associated with the uplink beam used for the PUSCH/PUCCH transmission in the SpCell is below a threshold.

In some embodiments, the UE initiated event driven beam report/L1 measurement report can be a MAC CE.

Although FIG. 4 illustrates one example method for UE triggered beam reporting 400, various changes may be made to FIG. 4. For example, while shown as a series of steps, various steps in FIG. 4 could overlap, occur in parallel, occur in a different order, occur any number of times, be omitted, or replaced by other steps.

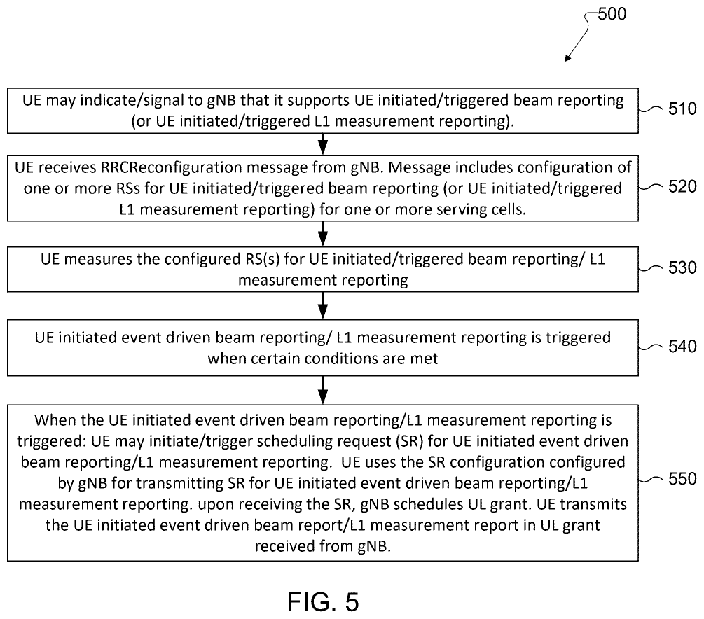

FIG. 5 illustrates another example method for UE triggered beam reporting 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

In the example of FIG. 5, method 500 is performed by a UE such as UE 116 of FIG. 1. In some embodiments, the UE may be in an RRC_CONNECTED state. In some embodiments, the UE may be in an RRC_IDLE/RRC_INACTIVE state.

Method 500 begins at step 510, which is an optional step. At step 510, the UE may indicate/signal to a gNB (e.g., BS 102 of FIG. 1) that the UE supports UE initiated/triggered beam reporting (or UE initiated/triggered L1 measurement reporting) capability, similarly as described regarding step 410 of FIG. 4.

At step 520, the UE receives an RRCReconfiguration message from the gNB, similarly as described regarding step 420 of FIG. 4.

At step 530, the UE performs the measurement (i.e., measures L1-RSRPs/RSRQs/SINRs etc. as configured, of the configured RSs for UE initiated/triggered beam reporting/L1 measurement reporting), similarly as described regarding step 430 of FIG. 4.

At step 540, a UE initiated event driven beam reporting/L1 measurement reporting may be triggered, similarly as described regarding step 440 FIG. 4.

At step 550, when a UE initiated event driven beam reporting/L1 measurement reporting is triggered, the UE may initiate/trigger scheduling request (SR) for UE initiated event driven beam reporting/L1 measurement reporting. In some embodiments, the UE may initiate/trigger the SR for UE initiated event driven beam reporting/L1 measurement reporting if the UE initiated event driven beam reporting/L1 measurement reporting is triggered (and is not canceled) and there is no UL grant available for new transmission. In some embodiments, the UE may initiate/trigger the SR for UE initiated event driven beam reporting/L1 measurement reporting if the UE initiated event driven beam reporting/L1 measurement reporting is triggered (and is not canceled) and the UL grant available for new transmission cannot accommodate the UE initiated event driven beam report/L1 measurement report.

In some embodiments, the gNB signals in an RRCReconfiguration message the SR configuration to be used for the SR triggered for the UE initiated event driven beam reporting/L1 measurement reporting. The gNB may signal one or more SR configurations in the RRCReconfiguration message. Each of these SR configurations is identified by a configuration ID. In some embodiments, the gNB signals the configuration ID of the SR configuration to be used for the SR for the UE initiated event driven beam reporting/L1 measurement reporting. The UE uses the SR configuration configured by the gNB for transmitting the SR for the UE initiated event driven beam reporting/L1 measurement reporting. In some embodiments, the SR configuration indicates an SR prohibit timer, maximum SR transmission and PUCCH resources for SR transmission. The SR configuration to be used for the SR triggered for the UE initiated event driven beam reporting/L1 measurement reporting can be separately configured for the MCG and the SCG. For UE initiated event driven beam reporting/L1 measurement reporting related to cells of the MCG or for UE initiated event driven beam reporting/L1 measurement reporting configured by the MCG or for UE initiated event driven beam reporting/L1 measurement reporting based on MCG configuration or for UE initiated event driven beam reporting/L1 measurement reporting triggered by a MAC entity of MCG or for UE initiated event driven beam reporting/L1 measurement reporting for which the report is to be sent to the MCG, the UE uses the MCG's SR configuration for the UE initiated event driven beam reporting/L1 measurement reporting. For UE initiated event driven beam reporting/L1 measurement reporting related to cells of the SCG or for UE initiated event driven beam reporting/L1 measurement reporting configured by the SCG or for UE initiated event driven beam reporting/L1 measurement reporting based on SCG configuration or for UE initiated event driven beam reporting/L1 measurement reporting triggered by a MAC entity of the SCG or for UE initiated event driven beam reporting/L1 measurement reporting for which report is to be sent to the SCG, the UE uses the SCG's SR configuration for the UE initiated event driven beam reporting/L1 measurement reporting.

In some embodiments, the UE transmits the SR using PUCCH resource indicated by the SR configuration for the UE initiated event driven beam reporting/L1 measurement reporting. In some embodiments, upon receiving the SR, the gNB schedules an UL grant. The UE transmits the UE initiated event driven beam report/L1 measurement report in the UL grant received from the gNB. Upon transmitting the report, the triggered SR is canceled.

In some embodiments, if valid PUCCH resources are not available for the SR triggered for the UE initiated event driven beam reporting/L1 measurement reporting, the UE initiates a random access procedure for the SpCell. Upon initiation of the random access procedure, the triggered SR for the UE initiated event driven beam report/L1 measurement report is canceled.

In some embodiments, if the SR was triggered by a UE initiated event driven beam reporting/L1 measurement reporting of a serving cell and a MAC PDU is transmitted and the MAC PDU includes the UE initiated event driven beam report/L1 measurement report for the serving cell, the UE cancels the pending SR and stops the corresponding sr-ProhibitTimer, if running.

In some embodiments, if the SR was triggered by a UE initiated event driven beam reporting/L1 measurement reporting of a serving cell and the UE initiated event driven beam report/L1 measurement report for the serving cell is transmitted, the UE cancels the pending SR and stops the corresponding sr-ProhibitTimer, if running.

In some embodiments, the UE may stop, if any, ongoing random access procedure due to an SR triggered by a UE initiated event driven beam reporting/L1 measurement reporting of a serving cell, which has no valid PUCCH resources configured, if a MAC PDU is transmitted using a UL grant other than a UL grant provided by a random access response or a UL grant for the transmission of the MsgA payload, and this PDU contains a UE initiated event driven beam report/L1 measurement report for the serving cell.

In some embodiments, if the SR was triggered by a UE initiated event driven beam reporting/L1 measurement reporting of an SCell and the SCell is deactivated, UE cancels this SR.

In some embodiments, the UE initiated event driven beam report/L1 measurement report can be a MAC CE.

Although FIG. 5 illustrates one example method for UE triggered beam reporting 500, various changes may be made to FIG. 5. For example, while shown as a series of steps, various steps in FIG. 5 could overlap, occur in parallel, occur in a different order, occur any number of times, be omitted, or replaced by other steps.

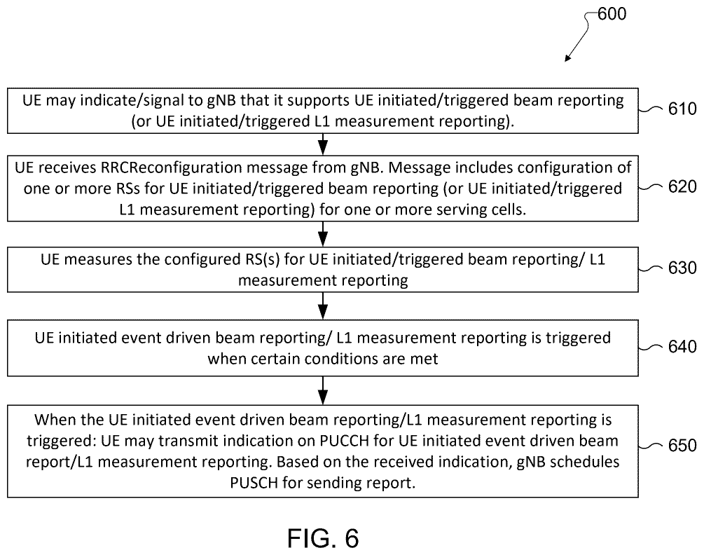

FIG. 6 illustrates another example method for UE triggered beam reporting 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

In the example of FIG. 6, method 600 is performed by a UE such as UE 116 of FIG. 1. In some embodiments, the UE may be in an RRC_CONNECTED state. In some embodiments, the UE may be in an RRC_IDLE/RRC_INACTIVE state.

Method 600 begins at step 610, which is an optional step. At step 610, the UE may indicate/signal to a gNB (e.g., BS 102 of FIG. 1) that the UE supports UE initiated/triggered beam reporting (or UE initiated/triggered L1 measurement reporting) capability, similarly as described regarding step 410 of FIG. 4.

At step 620, the UE receives an RRCReconfiguration message from the gNB, similarly as described regarding step 420 of FIG. 4.

At step 630, the UE performs the measurement (i.e., measures L1-RSRPs/RSRQs/SINRs etc. as configured, of the configured RSs for UE initiated/triggered beam reporting/L1 measurement reporting), similarly as described regarding step 430 of FIG. 4.

At step 640, a UE initiated event driven beam reporting/L1 measurement reporting may be triggered, similarly as described regarding step 440 FIG. 4.

At step 650, when a UE initiated event driven beam reporting/L1 measurement reporting is triggered, the UE may transmit an indication on a PUCCH for the UE initiated event driven beam report/L1 measurement reporting. Based on the received indication, the gNB schedules a PUSCH (or UL grant) for sending the report. In some embodiments, the indication on the PUCCH may indicate a request for resources/grant for the UE initiated event driven beam report/L1 measurement reporting. In some embodiments, the indication on the PUCCH may indicate the size of report. For example, the size of the report may be in a number of bits or resource elements or resource blocks.

In some embodiments, PUCCH resources may be configured for this indication to the UE by the gNB (e.g., using an RRC message such as an RRC Reconfiguration message). In some embodiments, the indication may be transmitted on a PUCCH of a SpCell. In some embodiments, the indication may be transmitted on a PUCCH of a PUCCH SCell. Whether to transmit the indication on the PUCCH of the SpCell or the PUCCH of the PUCCH SCell may be signaled by the gNB.

In some embodiments, PUCCH resources may be common for UE initiated event driven beam report/L1 measurement reporting indications of all serving cells configured with UE initiated event driven beam report/L1 measurement reporting. Alternately, PUCCH resources may be separately configured per serving cell for UE initiated event driven beam report/L1 measurement reporting indication of all serving cells configured with UE initiated event driven beam report/L1 measurement reporting.

In some embodiments, PUCCH resources may be configured for multiple beams (SSBs/RSs) and the UE selects the PUCCH resources corresponding to suitable beams (e.g., beams with an SSB/RS with RSRP above a threshold) for sending the indication.

Although FIG. 6 illustrates one example method for UE triggered beam reporting 600, various changes may be made to FIG. 6. For example, while shown as a series of steps, various steps in FIG. 6 could overlap, occur in parallel, occur in a different order, occur any number of times, be omitted, or replaced by other steps.

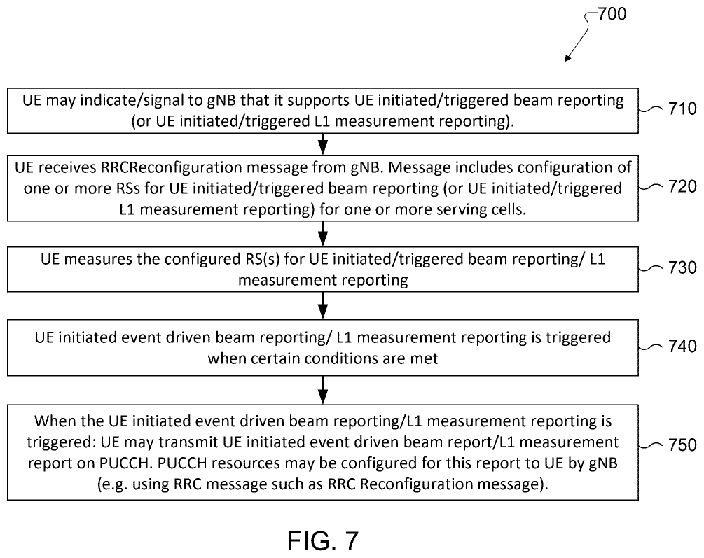

FIG. 7 illustrates another example method for UE triggered beam reporting 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

In the example of FIG. 7, method 700 is performed by a UE such as UE 116 of FIG. 1. In some embodiments, the UE may be in an RRC_CONNECTED state. In some embodiments, the UE may be in an RRC_IDLE/RRC_INACTIVE state.

Method 700 begins at step 710, which is an optional step. At step 710, the UE may indicate/signal to a gNB (e.g., BS 102 of FIG. 1) that the UE supports UE initiated/triggered beam reporting (or UE initiated/triggered L1 measurement reporting) capability, similarly as described regarding step 410 of FIG. 4.

At step 720, the UE receives an RRCReconfiguration message from the gNB, similarly as described regarding step 420 of FIG. 4.

At step 730, the UE performs the measurement (i.e., measures L1-RSRPs/RSRQs/SINRs etc. as configured, of the configured RSs for UE initiated/triggered beam reporting/L1 measurement reporting), similarly as described regarding step 430 of FIG. 4.

At step 740, a UE initiated event driven beam reporting/L1 measurement reporting may be triggered, similarly as described regarding step 440 FIG. 4.

At step 750, when a UE initiated event driven beam reporting/L1 measurement reporting is triggered, the UE may transmit UE initiated event driven beam report/L1 measurement report on PUCCH.

In some embodiments, PUCCH resources may be configured for this report to the UE by the gNB (e.g., using an RRC message such as an RRC Reconfiguration message). In some embodiments, the report may be transmitted on a PUCCH of an SpCell. In some embodiments, the report may be transmitted on a PUCCH of a PUCCH SCell. Whether to transmit the report on the PUCCH of the SpCell or the PUCCH of the PUCCH SCell may be signaled by gNB.

In some embodiments, the PUCCH resources may be common for UE initiated event driven beam report/L1 measurement reporting indication of all serving cells configured with UE initiated event driven beam report/L1 measurement reporting. Alternately, PUCCH resources may be separately configured per serving cell for UE initiated event driven beam report/L1 measurement reporting indication of all serving cells configured with UE initiated event driven beam report/L1 measurement reporting.

In some embodiments, PUCCH resources may be configured for multiple beams (SSBs/RSs) and the UE may select the PUCCH resources corresponding to suitable beam (e.g., with SSB/RS with RSRP above a threshold) for sending the report.

In some embodiments, before transmitting the UE initiated event driven beam report/L1 measurement report on a 2nd PUCCH, the UE may send a notification on a 1st PUCCH to the gNB. This notification indicates that the UE is going to transmit the report on the 2nd PUCCH. Resources for the 1st and 2nd PUCCH can be separately configured. The relation between PUCCH resource selected for the 1st and 2nd PUCCH can be as follows:

In some embodiments, the PUCCH resource (from PUCCH resources of the 2nd PUCCH) used for beam reporting is the earliest valid resource occurring after the end of a PUCCH resource (amongst the PUCCH resources of the 1st PUCCH) in which the notification is sent. In some embodiments, the PUCCH resource (from PUCCH resources of the 2nd PUCCH) used for the beam reporting is the earliest valid resource occurring after the end of a slot/symbol/subframe/frame containing the PUCCH resource (amongst the PUCCH resources of the 1st PUCCH) in which the notification is sent.

In some embodiments, the PUCCH resource (from PUCCH resources of the 2nd PUCCH) used for beam reporting is the earliest valid resource occurring after an offset from the end of the PUCCH resource (amongst the PUCCH resources of the 1st PUCCH) in which the notification is sent. In some embodiments, the PUCCH resource (from PUCCH resources of the 2nd PUCCH) used for beam reporting is the earliest valid resource occurring after an offset from the end of a slot/symbol/subframe/frame containing the PUCCH resource (amongst the PUCCH resources of the 1st PUCCH) in which the notification is sent. The Offset can be fixed or pre-defined or signaled by the gNB (e.g., in RRC signaling).

Although FIG. 7 illustrates one example method for UE triggered beam reporting 700, various changes may be made to FIG. 5. For example, while shown as a series of steps, various steps in FIG. 7 could overlap, occur in parallel, occur in a different order, occur any number of times, be omitted, or replaced by other steps.

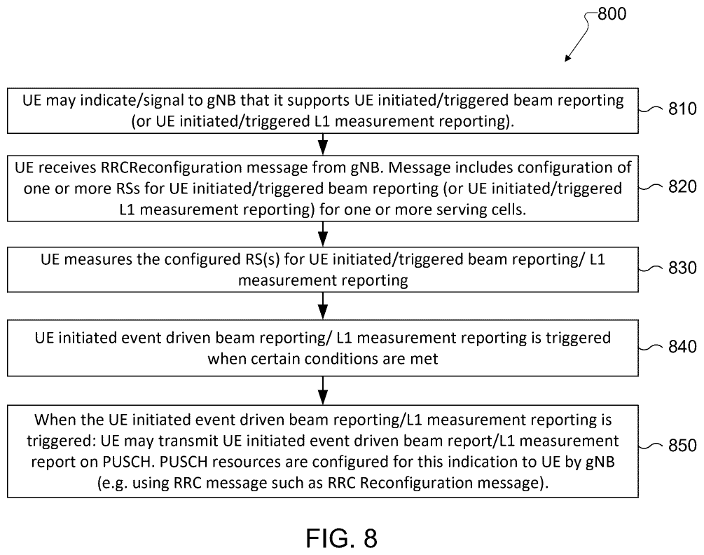

FIG. 8 illustrates another example method for UE triggered beam reporting 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

In the example of FIG. 8, method 800 is performed by a UE such as UE 116 of FIG. 1. In some embodiments, the UE may be in an RRC_CONNECTED state. In some embodiments, the UE may be in an RRC_IDLE/RRC_INACTIVE state.

Method 800 begins at step 810, which is an optional step. At step 810, the UE may indicate/signal to a gNB (e.g., BS 102 of FIG. 1) that the UE supports UE initiated/triggered beam reporting (or UE initiated/triggered L1 measurement reporting) capability, similarly as described regarding step 410 of FIG. 4.

At step 820, the UE receives an RRCReconfiguration message from the gNB, similarly as described regarding step 420 of FIG. 4.

At step 830, the UE performs the measurement (i.e., measures L1-RSRPs/RSRQs/SINRs etc. as configured, of the configured RSs for UE initiated/triggered beam reporting/L1 measurement reporting), similarly as described regarding step 430 of FIG. 4.

At step 840, a UE initiated event driven beam reporting/L1 measurement reporting may be triggered, similarly as described regarding step 440 FIG. 4.

At step 850, when a UE initiated event driven beam reporting/L1 measurement reporting is triggered, the UE may transmit a UE initiated event driven beam report/L1 measurement report on a PUSCH. In some embodiments, PUSCH resources are configured for this indication to the UE by the gNB (e.g., using an RRC message such as an RRC Reconfiguration message).

In some embodiments, the report may be transmitted on a PUSCH of a SpCell. In some embodiments, the report may be transmitted on a PUSCH of any serving cell. In some embodiments, the serving cell whose PUSCH is used for transmitting the report may be signaled to the UE by the gNB (e.g., using RRC message such as RRC Reconfiguration message or DCI or MAC CE).

In some embodiments, PUSCH resources can be common for UE initiated event driven beam report/L1 measurement reporting indication of all serving cells configured with UE initiated event driven beam report/L1 measurement reporting. Alternately, PUSCH resources can be separately configured per serving cell for UE initiated event driven beam report/L1 measurement reporting indication of all serving cells configured with UE initiated event driven beam report/L1 measurement reporting.

In some embodiments, PUSCH resources may be configured for multiple beams (SSBs/RSs) and the UE may select the PUSCH resources corresponding to suitable beams (e.g., with SSB/RS with RSRP above a threshold) for sending the report.

Although FIG. 8 illustrates one example method for UE triggered beam reporting 800, various changes may be made to FIG. 8. For example, while shown as a series of steps, various steps in FIG. 8 could overlap, occur in parallel, occur in a different order, occur any number of times, be omitted, or replaced by other steps.

In some embodiments, one or more pre-configured grant/resource configurations can be signaled to the UE for a UE initiated event driven beam report/L1 measurement report using RRC signaling. For example, the one or more configurations can be one or more PUCCH configurations or PUSCH configurations. In these embodiments, the UE first sends a notification to the gNB using the PUCCH and then sends the report using the PUSCH. In these embodiments, if multiple pre-configured grant/resource configuration are configured the UE may select a pre-configured grant/resource configuration based on the size of the beam report/L1 measurement report. The UE then selects a grant/resource from the selected pre-configured grant/resource configuration for beam reporting/L1 measurement reporting, and indicates the selected configuration for beam reporting/L1 measurement reporting to the gNB using a PUCCH (the PUCCH configuration for this notification can be received by the UE from the gNB using RRC signaling). The UE then transmits the beam report/L1 measurement report using the selected grant/resource.

In some embodiments, the resource/grant used for beam reporting is the earliest valid resource/grant (from resources/grants of the selected pre-configured grant/resource configuration) occurring after the end of the PUCCH resource (amongst the PUCCH resource for notification) in which the notification is sent. In some embodiments, the resource/grant (from resources/grants of the selected pre-configured grant/resource configuration) used for beam reporting is the earliest valid resource/grant occurring after the end of a slot/symbol/subframe/frame containing the PUCCH resource (amongst the PUCCH resource for notification) in which the notification is sent.

In some embodiments, the resource/grant used for beam reporting is the earliest valid resource/grant (from resources/grants of the selected pre-configured grant/resource configuration) occurring after an offset from the end of the PUCCH resource in which the notification is sent. In some embodiments, the resource/grant used for beam reporting is the earliest valid resource/grant (from resources/grants of the selected pre-configured grant/resource configuration) occurring after an offset from the end of a slot/symbol/subframe/frame containing the PUCCH resource in which the notification is sent. The offset can be fixed or pre-defined or signaled by the gNB (e.g., in RRC signaling).

Based on the notification on the PUCCH, the gNB can identify the selected pre-configured grant/resource configuration (if multiple pre-configured grant/resource configurations are configured) and the resource/grant from this selected configuration used by the UE for transmitting the beam report/L1 measurement report. The gNB then receives the beam report/L1 measurement report in the identified resource/grant.

In some embodiments, the UE receives a pre-configured resource/grant configuration from gNB using RRC signaling. For example, the configuration can be a PUCCH configuration or a PUSCH configuration. In these embodiments, the UE selects more than one consecutive resource/grant for beam reporting/L1 measurement reporting, and the UE indicates the number of consecutive resources/grants (valid resources/grants) to the gNB using a PUCCH. Alternatively, the resources/grants can be indexed, and indexes of the resources/grants can be indicated to the gNB. The UE then transmits the beam report/L1 measurement report using the selected multiple resources/grants.

In some embodiments, the first resource/grant used for beam reporting is the earliest valid resource/grant (from resources/grants of the selected pre-configured grant/resource configuration) occurring after the end of the PUCCH resource (amongst the PUCCH resources for notification) in which the notification is sent. In some embodiments, the first resource/grant (from resources/grants of the selected pre-configured grant/resource configuration) used for beam reporting is the earliest valid resource/grant occurring after the end of a slot/symbol/subframe/frame containing the PUCCH resource (amongst the PUCCH resources for notification) in which the notification is sent.

In some embodiments, the first resource/grant used for beam reporting is the earliest valid resource/grant (from resources/grants of the selected pre-configured grant/resource configuration) occurring after an offset from the end of the PUCCH resource in which the notification is sent. In some embodiments, the first resource/grant used for beam reporting is the earliest valid resource/grant (from resources/grants of the selected pre-configured grant/resource configuration) occurring after an offset from the end of a slot/symbol/subframe/frame containing the PUCCH resource in which the notification is sent. The offset can be fixed or pre-defined or signaled by the gNB (e.g., in RRC signaling).

Based on the notification on the PUCCH, the gNB can identify the resources/grants used by the UE for transmitting the beam report/L1 measurement report. The gNB then receives the beam report/L1 measurement report in the identified resources/grants.

In some embodiments, the UE receives a PUCCH configuration for a 1^{st} PUCCH channel and the UE receives a PUCCH configuration for a 2^{nd} PUCCH channel. In these embodiments, the UE transmits a 1^{st} PUCCH channel to request a resource for beam reporting/L1 measurement reporting, and the network (e.g., gNB) transmits a DCI indicating a PUCCH resource index, where the index indicates a PUCCH resource in the PUCCH configuration for the 2^{nd} PUCCH channel. The UE then transmits the beam report/L1 measurement report in the PUCCH resource indicated by the PUCCH resource index.

In some embodiments, a UE initiated event driven beam report/L1 measurement report may include a Serving Cell ID, one or more RS IDs of the Serving Cell (e.g., a PCell, PSCell, SCell, camped cell, neighbor cell, candidate cell for cell switch or handover etc.) identified by the Serving Cell ID, and measurements (e.g., L1 RSRP/SINR) of the included RS IDs. The RS IDs of RSs whose measurement is above threshold may be included in the report. A maximum number of RSs that can be included in the report can be configurable and signaled to the UE by the gNB using RRC. In some embodiments, and RS ID bitmap can be included, wherein bits in the bitmap are mapped in ascending order of RS IDs (i.e., RS IDs of RSs configured for a UE initiated event driven beam report/L1 measurement report) from least significant bit to most significant bit, or from most significant bit to least significant bit. In some embodiments, the report may indicate whether the report is an L1 measurement report or beam report.

In some embodiments, a UE initiated event driven beam report/L1 measurement report may include, for each serving cell for which a UE initiated event driven beam report/L1 measurement report is triggered, one or more of the following: a Serving Cell ID, one or more RS IDs of the Serving Cell (e.g., a PCell, PSCell, SCell, camped cell, neighbor cell, candidate cell for cell switch or handover etc.) identified by Serving Cell ID, and measurement (e.g., L1 RSRP/SINR) of the included RS IDs. The RS IDs of RSs whose measurement is above threshold may be included in report. The Maximum number of RSs that can be included in report can be configurable and signaled to the UE by the gNB using RRC. In some embodiments, an RS ID bitmap can be included wherein bits in the bitmap are mapped in ascending order of RS IDs (i.e., RS IDs of RSs configured for a UE initiated event driven beam report/L1 measurement report) from least significant bit to most significant bit, or from most significant bit to least significant bit.

In some embodiments, a UE initiated event driven beam report/L1 measurement report (MAC CE) may include a Ci bitmap. In these embodiments, a Ci field indicates presence of a UE initiated event driven beam report/L1 measurement report for the serving cell with ServCellIndex i. ServCellIndex i=0 (i.e., CO bit) is used for the SpCell. ServCellIndex is signaled in an RRC Reconfiguration message for the Serving Cell. The Ci field set to 1 indicates that a UE initiated event driven beam report/L1 measurement report is present for the serving cell with ServCellIndex i. The Cᵢ field set to 0 indicates that a UE initiated event driven beam report/L1 measurement report is not present for the serving cell with ServCellIndex i. The UE initiated event driven beam report/L1 measurement reports for the serving cell are present in ascending order based on the ServCellIndex after the Ci bitmap. The report may include one or more RS IDs of the Serving Cell and a measurement (e.g., L1 RSRP/SINR) of included RS IDs. In some embodiments, an RS ID bitmap can be included in the report wherein bits in bitmap are mapped in ascending order of RS IDs (i.e., RS IDs of RSs configured for a UE initiated event driven beam report/L1 measurement report) from least significant bit to most significant bit, or from most significant bit to least significant bit. In some embodiments, a single octet bitmap is used if the highest ServCellIndex of this MAC entity's serving cell for which a UE initiated event driven beam report/L1 measurement report is triggered/reported is less than 8. Otherwise, four octets are used. In some other embodiments, a single octet bitmap is used if the highest ServCellIndex of this MAC entity's serving cell for which a UE initiated event driven beam report/L1 measurement report is configured is less than 8. Otherwise, four octets are used.

In some embodiments, if the UE is unable to include reports of all serving cells for which a report is triggered, the UE prioritizes inclusion of reports in ascending order of ServCellIndex i starting with SpCell with index i=0.

In some embodiments, when the MAC entity/UE has a pending SR for a UE initiated event driven beam report/L1 measurement report and the MAC entity has one or more PUCCH resources (other than PUCCH resources of the pending SR for beam failure recovery, such as an SR for a BSR, SR for a consistent LBT failure recovery, SR for a positioning measurement gap activation/deactivation request, SR for a timing advance reporting, etc.) overlapping with the PUCCH resource for the UE initiated event driven beam report/L1 measurement report for the SR transmission occasion, the MAC entity/UE considers only the PUCCH resource for the UE initiated event driven beam report/L1 measurement report as valid.

In some embodiments, when the UE has a pending UE initiated event driven beam report/L1 measurement report and the one or more PUCCH resources (other than PUCCH resources of a pending SR for beam failure recovery, such as a SR for a BSR, SR for a consistent LBT failure recovery, SR for a positioning measurement gap activation/deactivation request, SR for a timing advance reporting, etc) overlapping with the PUCCH resource for the UE initiated event driven beam report/L1 measurement report, the UE considers only the PUCCH resource for UE initiated event driven beam report/L1 measurement report as valid (i.e., the UE will transmit the UE initiated event driven beam report/L1 measurement report).

In some embodiments, when the UE has a PUCCH resource for the UE initiated event driven beam report/L1 measurement report overlapping with a PUCCH resource for beam failure recovery for the SR transmission occasion, the MAC entity/UE considers only the PUCCH resource for beam failure recovery as valid.

In some embodiments, when the UE has a PUCCH resource for the UE initiated event driven beam report/L1 measurement report overlapping with a PUCCH resource for beam failure recovery (in the same transmission occasion), the UE considers only the PUCCH resource for beam failure recovery as valid (i.e., the UE will not transmit the UE initiated event driven beam report/L1 measurement report).

In some embodiments, when the UE has a PUCCH resource for the UE initiated event driven beam report/L1 measurement report overlapping with a PUCCH resource for beam failure recovery for the SR transmission occasion, the MAC entity/UE considers only the PUCCH resource for the UE initiated event driven beam report/L1 measurement report as valid.

In some embodiments, when the UE has a PUCCH resource for the UE initiated event driven beam report/L1 measurement report overlapping with a PUCCH resource for beam failure recovery (in the same transmission occasion), the UE considers only the PUCCH resource for UE initiated event driven beam report/L1 measurement report as valid (i.e., the UE will transmit the UE initiated event driven beam report/L1 measurement report).

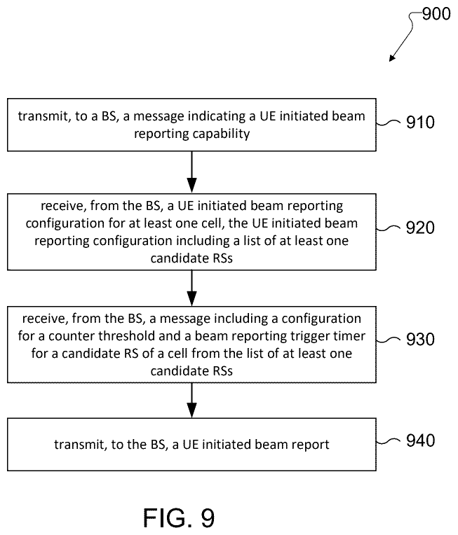

FIG. 9 illustrates another example method for UE triggered beam reporting 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

Method 900 begins at step 910. At step 910, a UE (e.g., UE 116 of FIG. 1) transmits, to a BS (e.g., BS 102 of FIG. 1), a message indicating a UE initiated beam reporting capability.

At step 920, the UE receives, from the BS, a UE initiated beam reporting configuration for at least one cell, the UE initiated beam reporting configuration including a list of at least one candidate RSs,

At step 930, the UE receives, from the BS, a message including a configuration for a counter threshold and a beam reporting trigger timer.

In some embodiments, the configuration for the counter threshold and the beam reporting trigger timer is one of a per serving cell configuration, a per cell group configuration, and a per BWP configuration.

Finally, at step 940, the UE transmits, to the BS, a UE initiated beam report.

In some embodiments, to transmit the UE initiated beam report to the BS, the UE determines whether an UL grant is available for transmission of the UE initiated beam report, and in response to a determination that the UL grant for transmission of the UE initiated beam report is not available, transmits, to the BS, a SR for the UE initiated beam reporting. Afterwards, the UE receives, from the BS, an UL grant, and the UE initiated beam report is transmitted to the BS in the UL grant.

In some embodiments, the UE receives, from the BS, an SR configuration for the UE initiated beam reporting, and the SR is transmitted based on the SR configuration for the UE initiated beam reporting.

In some embodiments, the UE determines whether a value of a beam reporting trigger counter for a candidate RS from the list exceeds the counter threshold, and the UE initiated beam report is transmitted to the BS in response to the value exceeding the counter threshold.

In some embodiments, the UE determines whether a layer 1-reference signal received power (L1-RSRP) of the candidate RS exceeds by a threshold an L1-RSRP of an RS quasi-collocated (QCLed) with an activated transmission configuration indication (TCI) state of the cell, and in response to the L1-RSRP of the candidate RS exceeding the threshold, the UE starts or restarts the beam reporting trigger timer for the candidate RS, and increments the beam reporting trigger counter for the candidate RS by one.

In some embodiments, the UE determines whether the beam reporting trigger timer for the candidate RS has expired, and in response in response to a determination that the beam reporting trigger timer for the candidate RS has expired, the UE sets the beam reporting trigger counter for the candidate RS to zero.

Although FIG. 9 illustrates one example method for UE triggered beam reporting 900, various changes may be made to FIG. 9. For example, while shown as a series of steps, various steps in FIG. 9 could overlap, occur in parallel, occur in a different order, occur any number of times, be omitted, or replaced by other steps.

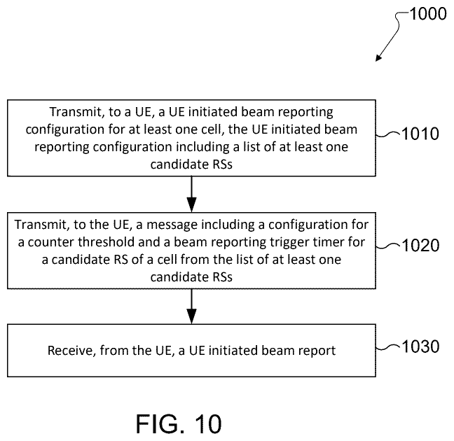

FIG. 10 illustrates another example method for UE triggered beam reporting 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for UE triggered beam reporting could be used without departing from the scope of this disclosure.

Method 1000 begins at step 1010. At step 910, a BS (e.g., BS 102 of FIG. 1) transmits, to a UE (e.g., UE 116 of FIG. 1), a UE initiated beam reporting configuration for at least one cell, the UE initiated beam reporting configuration including a list of at least one candidate reference signals (RSs).

In some embodiments, prior to step 1010, the BS receives, from a user equipment (UE), a message indicating a UE initiated beam reporting capability, and the UE initiated beam reporting configuration for the at least one cell is transmitted to the UE in response to receiving the message indicated the UE initiated beam reporting capability.

At step 1020, the BS transmits, to the UE, a message including a configuration for a counter threshold and a beam reporting trigger timer.

In some embodiments, the configuration for the counter threshold and the beam reporting trigger timer is one of a per serving cell configuration, a per cell group configuration, and a per BWP configuration.

Finally, at step 1030, the BS receives, from the UE, a UE initiated beam report.

In some embodiment, prior to step 1030, the BS receives, from the UE, a scheduling request (SR) for the UE initiated beam reporting, and the BS transmits, to the UE, a UL grant. The UE initiated beam report is transmitted to the BS in the UL grant. In some embodiments, the UL grant is for a PUCCH resource.

In some embodiments, the BS transmits, to the UE, an SR configuration for the UE initiated beam reporting, and the SR is received based on the SR configuration for the UE initiated beam reporting.

Although FIG. 10 illustrates one example method for UE triggered beam reporting 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor; and
a transceiver operatively coupled to the processor, the transceiver configured to:
transmit, to a base station (BS), a message indicating a UE initiated beam reporting capability;
receive, from the BS, a UE initiated beam reporting configuration for at least one cell, the UE initiated beam reporting configuration including a list of at least one candidate reference signals (RSs);
receive, from the BS, a message including a configuration for a counter threshold and a beam reporting trigger timer; and
transmit, to the BS, a UE initiated beam report.

2. The UE of claim 1, wherein to transmit the UE initiated beam report to the base station:
the processor is configured to determine whether an uplink (UL) grant is available for transmission of the UE initiated beam report; and
the transceiver is further configured to:
in response to a determination that the UL grant for transmission of the UE initiated beam report is not available, transmit, to the BS, a scheduling request (SR) for the UE initiated beam reporting; and
receive, from the BS, an UL grant,
wherein the UE initiated beam report is transmitted to the base station in the UL grant.

3. The UE of claim 2, wherein:
the transceiver is further configured to receive, from the BS, an SR configuration for the UE initiated beam reporting; and
the SR is transmitted based on the SR configuration for the UE initiated beam reporting.

4. The UE of claim 1, wherein:
the processor is configured to determine whether a value of a beam reporting trigger counter for a candidate RS from the list exceeds the counter threshold; and
the transceiver is further configured to transmit the UE initiated beam report to the BS in response to the value exceeding the counter threshold.

5. The UE of claim 4, wherein the processor is further configured to:
determine whether a layer 1-reference signal received power (L1-RSRP) of the candidate RS exceeds by a threshold an L1-RSRP of an RS quasi-collocated (QCLed) with an activated transmission configuration indication (TCI) state of the cell; and
in response to the L1-RSRP of the candidate RS exceeding the threshold:
start or restart the beam reporting trigger timer for the candidate RS; and
increment the beam reporting trigger counter for the candidate RS by one.

6. The UE of claim 5, wherein the processor is further configured to:
determine whether the beam reporting trigger timer for the candidate RS has expired; and
in response to a determination that the beam reporting trigger timer for the candidate RS has expired, set the beam reporting trigger counter for the candidate RS to zero.

7. The UE of claim 1, wherein the configuration for the counter threshold and the beam reporting trigger timer is one of:
a per serving cell configuration;
a per cell group configuration; and
a per bandwidth part (BWP) configuration.

8. A base station (BS) comprising:
a processor; and
a transceiver operatively coupled to the processor, the transceiver configured to:
transmit, to a user equipment (UE), a UE initiated beam reporting configuration for at least one cell, the UE initiated beam reporting configuration including a list of at least one candidate reference signals (RSs);
transmit, to the UE, a message including a configuration for a counter threshold and a beam reporting trigger timer; and
receive, from the UE, a UE initiated beam report.

9. The BS of claim 8, wherein the transceiver is further configured to:
receive, from the UE, a scheduling request (SR) for the UE initiated beam reporting; and
transmit, to the UE, an uplink (UL) grant,
wherein the UE initiated beam report is transmitted to the BS in the UL grant.

10. The BS of claim 9, wherein:
the transceiver is further configured to transmit, to the UE, an SR configuration for the UE initiated beam reporting; and
the SR is received based on the SR configuration for the UE initiated beam reporting.

11. The BS of claim 9, wherein the UL grant is for a physical uplink control channel (PUCCH) resource.

12. The BS of claim 8, wherein the configuration for the counter threshold and the beam reporting trigger timer is one of:
a per serving cell configuration;
a per cell group configuration; and
a per bandwidth part (BWP) configuration.

13. The BS of claim 8, wherein:
the transceiver is further configured to receive, from a user equipment (UE), a message indicating a UE initiated beam reporting capability; and
the UE initiated beam reporting configuration for the at least one cell is transmitted to the UE in response to receiving the message indicated the UE initiated beam reporting capability.

14. A method of operating a user equipment (UE), the method comprising:
transmitting, to a base station (BS), a message indicating a UE initiated beam reporting capability;
receiving, from the BS, a UE initiated beam reporting configuration for at least one cell, the UE initiated beam reporting configuration including a list of at least one candidate reference signals (RSs);
receiving, from the BS, a message including a configuration for a counter threshold and a beam reporting trigger timer; and
transmitting, to the BS, a UE initiated beam report.

15. The method of claim 14, wherein to transmit the UE initiated beam report to the BS, the method further comprises:
determining whether an uplink (UL) grant is available for transmission of the UE initiated beam report;
in response to a determination that the UL grant for transmission of the UE initiated beam report is not available, transmitting, to the BS, a scheduling request (SR) for the UE initiated beam reporting; and
receiving, from the BS, an UL grant,
wherein the UE initiated beam report is transmitted to the BS in the UL grant.

16. The method of claim 15, further comprising:
receiving, from the BS, an SR configuration for the UE initiated beam reporting,
wherein the SR is transmitted based on the SR configuration for the UE initiated beam reporting.

17. The method of claim 14, further comprising:
determining whether a value of a beam reporting trigger counter for a candidate RS from the list exceeds the counter threshold,
wherein the UE initiated beam report is transmitted to the BS in response to the value exceeding the counter threshold.

18. The method of claim 17, further comprising:
determining whether a layer 1-reference signal received power (L1-RSRP) of the candidate RS exceeds by a threshold an L1-RSRP of an RS quasi-collocated (QCLed) with an activated transmission configuration indication (TCI) state of the cell; and
in response to the L1-RSRP of the candidate RS exceeding the threshold:
starting or restarting the beam reporting trigger timer for the candidate RS; and
incrementing the beam reporting trigger counter for the candidate RS by one.

19. The method of claim 18, further comprising:
determining whether the beam reporting trigger timer for the candidate RS has expired; and
in response to a determination that the beam reporting trigger timer for the candidate RS has expired, setting the beam reporting trigger counter for the candidate RS to zero.

20. The method of claim 14, wherein the configuration for the counter threshold and the beam reporting trigger is one of:
a per serving cell configuration;
a per cell group configuration; and
a per bandwidth part (BWP) configuration.
